(19) United States
(12) Patent Application Publication
(10) Pub. No.: US 2022/0088704 A1
(43) Pub. Date: Mar. 24, 2022

(54) MULTI-SOURCE LASER HEAD FOR LASER ENGRAVING

(71) Applicant: Standex International Corporation, Salem, NH (US)

(72) Inventors: Massimiliano MORUZZI, Rockford, IL (US); Francesco IORIO, Toronto (CA)

(21) Appl. No.: 17/476,233

(22) Filed: Sep. 15, 2021

Related U.S. Application Data
(60) Provisional application No. 63/080,644, filed on Sep. 18, 2020.

(51) Int. Cl. B23K 26/06; B23K 26/362; G02B 6/32

(52) U.S. Cl. CPC B23K 26/0648; G02B 6/32; B23K 26/362

(57) ABSTRACT

An optical device includes: a first connector for a first optical fiber that transmits a first laser beam from a first laser source; a second connector for a second optical fiber that transmits a second laser beam from a second laser source; and one or more optical elements that direct the first laser beam from the first connector to a first beam collimator and direct the second laser beam from the second connector to the first beam collimator, wherein, the first beam collimator: produces a first collimated beam based on the first laser beam, directs the first collimated beam to a laser-scanning device, produces a second collimated beam based on the second laser beam, and directs the second collimated beam to the laser-scanning device.

### CROSS-REFERENCE TO RELATED APPLICATIONS

This application claims priority benefit of the United States Provisional Patent Application titled, “MULTI-SOURCE LASER HEAD,” filed on Sep. 18, 2020 and having Ser. No. 63/080,644. The subject matter of this related application is hereby incorporated herein by reference.

### FIELD OF THE VARIOUS EMBODIMENTS

The various embodiments relate generally to laser engraving and, more specifically, to a multi-source laser head for laser-engraving.

### DESCRIPTION OF THE RELATED ART

Laser engraving is a technique where a focused laser beam is used to generate a specific geometric pattern on a surface of a material. By injecting energy onto the material surface via the focused laser beam, discrete locations on the material surface are heated, and portions of the material are displaced and/or vaporized. Patterned surface geometries formed in this way can render a desired aesthetic texture on the material surface and/or create geometric microstructures that alter the material properties of the surface. Currently, nanosecond pulse-width laser sources employed during laser engraving operations are capable of accurately generating surface textures on a wide variety of materials and with a resolution on the order of a few tens of microns.

To engrave a particular surface geometry on a workpiece surface, one or more laser-scanning operations are performed on the workpiece surface. Each laser-scanning operation is usually performed using a different laser source that is included in a different laser-scanning station. For example, an initial roughing operation could be performed with a higher-power and/or a longer pulse-width laser source, such as a nanosecond pulse-width laser, to remove a larger amount of material from a workpiece surface. A subsequent finishing operation could then be performed with a lower-power and/or a shorter pulse-width laser source, such as a femptosecond pulse-width laser, to produce high-resolution texturization on the workpiece surface.

One drawback of the above approach to laser engraving is that the laser sources associated with the various laser-scanning operations usually are located at different laser-scanning stations. Accordingly, during the laser-engraving process, a workpiece usually has to be moved between the different laser-scanning stations in order to perform the different laser-scanning operations. When relocating the workpiece from one laser-engraving station to another, misalignments between the existing surface geometries produced by the previous laser-scanning operations and the surface geometry being applied in the current laser-scanning operation have to be substantially mitigated, if not prevented completely. As a result, relocating a workpiece to a new laser-scanning station involves probing, registering, and then precisely positioning the workpiece on the new laser-scanning station, which can be a time-consuming process. Further, the accuracy with which a relocated workpiece can be positioned on a new laser-scanning station generally is far less than the resolutions available to conventional laser-scanning systems. For example, textures having approximately micron-sized and smaller features can be produced by either nanosecond, picosecond, or femtosecond pulse-width laser sources. However, repeatably positioning workpieces on a laser-scanning station with an accuracy of anything less than about 50 microns or more is impracticable if not impossible. Consequently, texturizations on workpiece surfaces that are generated by multiple laser-scanning operations and include high-resolution features cannot be produced by currently available laser-scanning systems.

As the foregoing illustrates, what is needed in the art are more effective ways to generate higher-resolution features on laser-engraved workpiece surfaces.

### SUMMARY

An optical device includes: a first connector for a first optical fiber that transmits a first laser beam from a first laser source; a second connector for a second optical fiber that transmits a second laser beam from a second laser source; and one or more optical elements that direct the first laser beam from the first connector to a first beam collimator and direct the second laser beam from the second connector to the first beam collimator, wherein, the first beam collimator: produces a first collimated beam based on the first laser beam, directs the first collimated beam to a laser-scanning device, produces a second collimated beam based on the second laser beam, and directs the second collimated beam to the laser-scanning device.

At least one technical advantage of the disclosed system relative to the prior art is that the disclosed system enables multiple laser-scanning operations to be performed on a given workpiece surface without having to move the workpiece to different laser-scanning stations. Thus, with the disclosed system, the workpiece does not need to be repositioned between laser-scanning operations. As a result, high-resolution features that can be formed by nanosecond, picosecond, and femtosecond laser sources can be generated on a workpiece surface even when multiple laser sources and multiple laser-scanning operations are needed to generate those features. A further advantage is that multiple laser-scanning operations can be performed on a workpiece without the delay associated with repositioning the workpiece on different laser-scanning stations. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a laser-engraving system configured to implement one or more aspects of the various embodiments.

FIG. 2 is a more detailed illustration of the multi-source interface module of FIG. 1, according to various embodiments.

FIG. 3 is a more detailed illustration of the multi-source interface module of FIG. 1, according to other various other embodiments.

FIG. 4 is a more detailed illustration of the multi-source interface module of FIG. 1, according to other various embodiments.

FIG. 5 is a more detailed illustration of the multi-source interface module of FIG. 1, according to other various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### Laser-Engraving System with Multiple Laser Sources

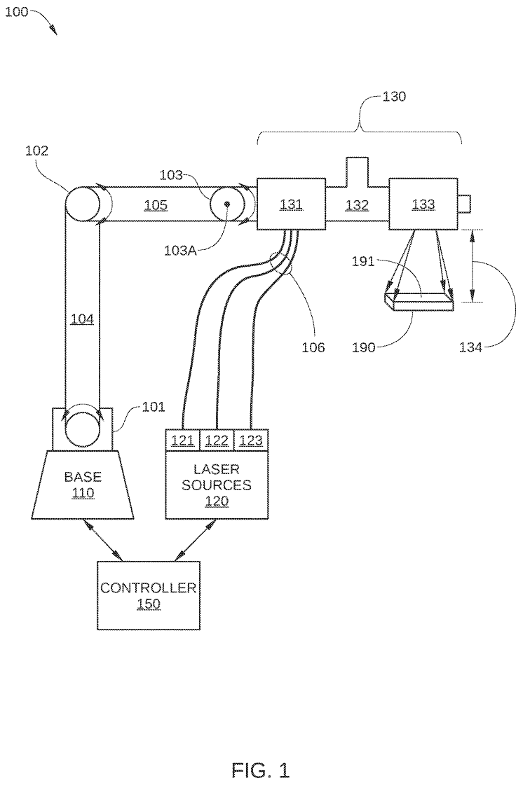

FIG. 1 illustrates a laser-engraving system 100 configured to implement one or more aspects of the various embodiments. Laser-engraving system 100 is a laser-engraving apparatus or station that is configured to generate surface geometries and/or textures on a surface 191 of a workpiece 190. More specifically, laser-engraving system 100 is configured to generate such geometries and/or textures via multiple laser-scanning operations, in which each laser-scanning operation employs a different laser source. Thus, a particular surface geometry or texture that is formed via multiple laser-scanning operations can be generated on surface 191 without workpiece 190 being moved to multiple laser-engraving stations. In the embodiment illustrated in FIG. 1, laser-engraving system 100 includes a base 110, laser sources 120, a laser-engraving head assembly 130, and arms 104 and 105 that are coupled as shown to a base joint 101, an elbow joint 102, and a wrist joint 103. In other embodiments, laser-engraving system 100 includes more than or fewer than two arms and/or more than or fewer than three joints. Laser-engraving system 100 also includes optical fibers 106 that optically couple laser sources 120 to laser-engraving head assembly 130. Optical fibers 106 can include any technically feasible optical fiber optics or crystal photonic fiber.

Base 110 is coupled to arm 104 via base joint 101. In some embodiments, base 110 is fixed in position relative to workpiece 190, for example to a supporting surface (not shown). In other embodiments, base 110 is configured to move relative to workpiece 190, for example in two or three dimensions. In addition, base joint 101, elbow joint 102, and wrist joint 103 are configured to position laser-engraving head assembly 130 with respect to workpiece 190 in one or more dimensions. Together, base joint 101, elbow joint 102, wrist joint 103, and arms 104 and 105 form a multi-axis positioning apparatus that locates and orients engraving head assembly 130 in two or three dimensions with respect to workpiece 190. In operation, the positioning apparatus sequentially positions engraving head assembly 130 at different positions over surface 191 of workpiece 190, so that discrete engraving regions can undergo laser engraving and have a final pattern formed thereon, such as a texture or other surface geometry.

In the embodiment illustrated in FIG. 1, base joint 101, elbow joint 102, and wrist joint 103 are depicted to each have at least one degree of freedom, for example rotation about an axis. In other embodiments, base joint 101, elbow joint 102, and/or wrist joint 103 are configured to have two or more degrees of freedom. For example, in one such embodiment, wrist joint 103 is configured to rotate about a first axis 103A and about a second axis (not shown) that is parallel to a longitudinal axis of arm 105. Similarly, base joint 101 and/or elbow joint 102 can be configured to rotate about multiple axes.

Laser sources 120 are configured as an assembly, array, or other apparatus that includes multiple independent laser sources. Alternatively, each of laser sources 120 is associated with a separate apparatus. In the embodiment illustrated in FIG. 1, laser sources 120 include three laser sources 121, 122, and 123, but in other embodiments, laser sources 120 include fewer than three laser sources or more than three laser sources.

Each of laser sources 120 is a laser source suitable for use by laser-engraving head assembly 130 in a laser-engraving process. For example, in an embodiment, laser source 121 is a longer pulse-width laser source, such as a nanosecond pulse-width laser, that is capable of generating a first laser beam of a first laser power (e.g., about 100 W), laser source 122 is a shorter pulse-width laser source, such as a picosecond pulse-width laser, that is capable of generating a second laser beam of a second laser power (e.g., about 75 W), and laser source 123 is a still shorter pulse-width laser source, such as a femtosecond pulse-width laser, that is capable of generating a third laser beam of a third laser power (e.g., about 50 W). In some embodiments, the first laser beam, the second laser beam, and the third laser beam each have a different spot size, and in other embodiments, some or all of the first laser beam, the second laser beam, and the third laser beam have the same spot size. Because laser sources 121, 122, and 123 can each generate a laser beam with a different pulse-width and/or spot size, each of laser sources 121, 122, and 123 can be employed in a different laser-scanning operation of a laser-scanning process being performed on workpiece 190. Thus, in some embodiments, each of laser sources 120 can be employed in a different laser-engraving operation of a laser-engraving process.

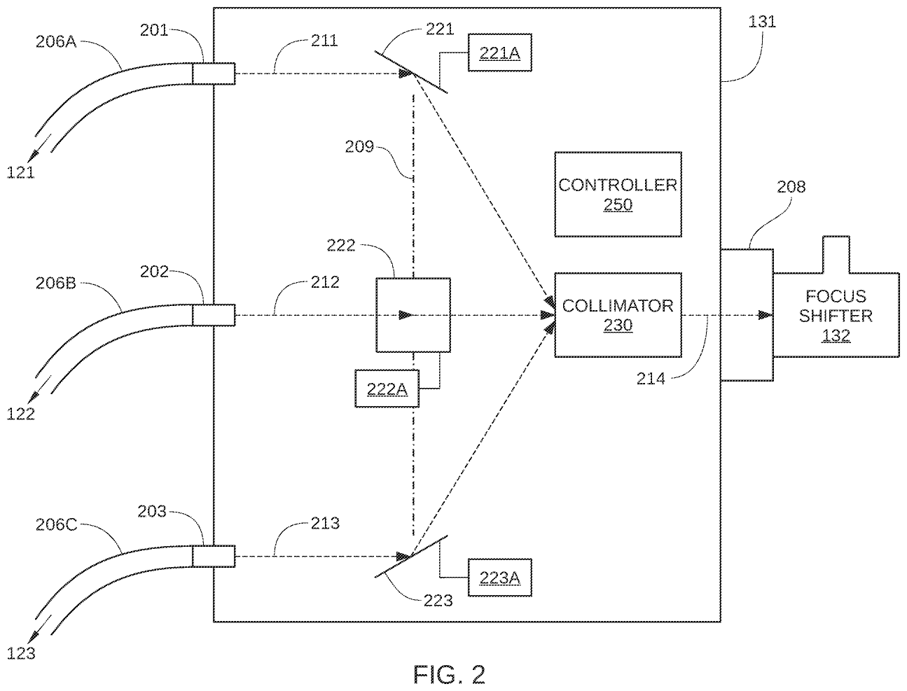

Engraving head assembly 130 is coupled to wrist joint 103 as an end effector of laser-engraving system 100, and is configured to laser engrave a final pattern into surface 191 of workpiece 190. In the embodiment illustrated in FIG. 1, engraving head assembly 130 includes a multi-source interface module 131, a focus shifter 132, and a laser-scanning head 133. Multi-source interface module 131 is configured to receive a laser beam one of multiple laser sources 120 and to selectively direct the received laser beam into focus shifter 132. Various embodiments of multi-source interface module 131 are described below in conjunction with FIGS. 2-4. Focus shifter 132, also referred to as a “dynamic focal module,” is a well-known optical device configured to change a focal length of a laser beam received from laser sources 120 to compensate for changes in a distance 134 between laser-scanning head 133 and surface 191 during three-dimensional scanning operations. Laser-scanning head 133 is a well-known optical device that includes a mirror positioning system and other laser optics that direct laser pulses received from focus shifter 132 to specific locations on surface 191 of workpiece 190. For example, in some embodiments, laser-scanning head 133 includes a 2-axis deflection unit (not shown) that deflects a laser beam in two directions and enables the laser beam to be directed to precise locations within a two-dimensional area. Typically, the 2-axis deflection unit is configured with two galvanometer scanners that each deflect the laser beam along a different direction within the two-dimensional area.

Controller 150 is configured to enable the operation of laser-engraving system 100, including controlling laser sources 120 and the components of laser-engraving assembly 100, so that a specific laser-scanning operation is performed on surface 191. Thus, in some embodiments, controller 150 implements specific laser source parameters, mirror positioning parameters, and/or laser source-selection parameters so that a laser pulse of specified size and energy is directed to a specified location on surface 191. For example, in some embodiments, controller 150 implements such parameters in a suitable control algorithm. Parameters for the laser source may include laser power, pulse frequency, and/or laser spot size, among others. Parameters for the movement of the laser beam with respect to the surface include engraving speed (e.g., the linear speed at which a laser spot moves across the surface being processed), laser incidence angle with respect to the surface being processed, and/or laser trajectory. Parameters for laser-source selection may include control signal values for one or more optical devices included in multi-source interface module 131 that selectively direct a laser beam from one of laser sources 120 to focus shifter 132.

In some embodiments, another controller (not shown) included in multi-source interface module 131 controls the operation of certain components of multi-source interface module 131 during such laser-scanning operations, for example via a suitable control algorithm. Additionally or alternatively, in some embodiments, another controller (not shown) included in laser-scanning head 133 controls the operation of certain components of laser-scanning head 133 during such laser-scanning operations, while in other embodiments, controller 150 controls such components.

FIG. 2 is a more detailed illustration of multi-source interface module 131 of laser-engraving system 100, according to various embodiments. Multi-source interface module 131 is configured to receive a laser beam from one of multiple laser sources 120 and to selectively direct the received laser beam to focus shifter 132 via one or more optical elements 220 and a collimator 230. In some embodiments, multi-source interface module 131 further includes a controller 250 that is configured to enable the operation of multi-source module 131, including controlling the motion and position of the one or more optical elements 220. Alternatively, in some embodiments, the above-described functionality of controller 250 is implemented by controller 150 in FIG. 1.

In the embodiment illustrated in FIG. 2, multi-source interface module 131 is configured to receive a different laser beam from each of laser source 121, 122, and 123 via a respective optical fiber. Thus, in the embodiment illustrated in FIG. 2, multi-source interface module 131 includes a first optical fiber connector 201 that is coupled to an optical fiber 206A from laser source 121, a second optical fiber connector 202 that is coupled to an optical fiber 206B from laser source 122, and a third optical fiber connector 203 that is coupled to an optical fiber 206C from laser source 123. Further, in the embodiment, a first laser beam 211 conveyed by optical fiber 206A leaves first optical fiber connector 201 and is directed to collimator 230 by one or more optical elements 220, a second laser beam 212 conveyed by optical fiber 206B leaves second optical fiber connector 202 and is directed to collimator 230 by one or more optical elements 220, and a third laser beam 213 conveyed by optical fiber 206C leaves first optical fiber connector 203 and is directed to collimator 230 by one or more optical elements 220.

In some embodiments, optical elements 220 include at least one movable mirror configured to selectively direct first laser beam 211, second laser beam 212, and third laser beam 213 to beam collimator 230. In the embodiment illustrated in FIG. 2, optical elements 220 include a movable mirror for each laser beam received by multi-source interface module 131. Thus, in the embodiment, optical elements 220 include a first movable mirror 221 mechanically coupled a mirror-moving mechanism 221A, a second movable mirror 222 mechanically coupled a mirror-moving mechanism 222A, and a third movable mirror 223 mechanically coupled a mirror-moving mechanism 223A. In such embodiments, mirror-moving mechanism 221A can be configured to rotate and/or linearly translate first movable mirror 221 so that first laser beam 211 is directed to collimator 230, mirror-moving mechanism 222A can be configured to rotate and/or linearly translate second movable mirror 222 so that second laser beam 212 is directed to collimator 230, and mirror-moving mechanism 223A can be configured to rotate and/or linearly translate third movable mirror 223 so that third laser beam 213 is directed to collimator 230.

Mirror-moving mechanisms 221A, 222A, and/or 223A can each include a rotational actuator for rotating an associated mirror with respect to an incident laser beam and/or a linear-translation mechanism for linearly translating the associated mirror with respect to the incident laser beam. Examples of rotational actuators suitable for use in optical elements 220 include a galvanometer optical scanner or other motorized rotatable mirror mount, a stepper motor-based actuator, a linear motor (configured in a circular array), and the like. Examples of linear translation mechanisms suitable for use in optical elements 220 include a one- or two-axis stepper motor, one or two linear motors, and the like. In some embodiments, mirror-moving mechanisms 221A, 222A, and/or 223A are configured to linearly translate an associated movable mirror along an axis 209 that is perpendicular to first laser beam 211, second laser beam 212, and/or third laser beam 213. Further, in some embodiments, mirror-moving mechanisms 221A, 222A, and/or 223A are configured to linearly translate an associated movable mirror within a plane that is perpendicular to first laser beam 211, second laser beam 212, and/or third laser beam 213, i.e., along two axes that are perpendicular to first laser beam 211, second laser beam 212, and/or third laser beam 213.

In some embodiments, rotation and/or linear translation of first movable mirror 221, second movable mirror 222, and/or third movable mirror 223 is employed in multi-source interface module 131 to selectively direct first laser beam 211, second laser beam 212, and/or third laser beam 213 to collimator 230. For example, in an instance in which first laser beam 211 is employed in a laser-scanning operation, first movable mirror 221 is rotated and/or linearly translated by mirror-moving mechanisms 221A so that first laser beam 211 is directed to collimator 230. Further, in some embodiments, laser beams that are not employed in the current laser-engraving process may be directed away from collimator 230, for example toward a light dump (not shown). For example, when second laser beam 212 is not employed in the current laser-engraving process, second movable mirror 222 may be positioned to direct second laser beam 212 away from collimator 230.

Additionally or alternatively, in some embodiments, rotation and/or linear translation of first movable mirror 221, second movable mirror 222, and/or third movable mirror 223 is employed in multi-source interface module 131 to facilitate calibration or other tuning of the path of first laser beam 211, second laser beam 212, and/or third laser beam 213 to collimator 230. For example, in some embodiments, changes in the position and/or orientation of optical elements 220 and/or collimator 230 due to temperature-based drift and/or vibration-induced displacement can be compensated for via mirror-moving mechanisms 221A, 222A, and/or 223A.

Collimator 230 is configured to receive a laser beam (e.g., first laser beam 211, second laser beam 212, or third laser beam 213) and produce a collimated laser beam 214 that is directed to focus shifter 132. In some embodiments, collimator 230 includes an aspherical lens (not shown) that is configured to straighten incident laser beams so that such laser beams do not undergo significant enlargement prior to reaching a workpiece surface.

In some embodiments, multi-source interface module 131 includes a mechanical interface 208 for coupling multi-source interface module 131 to focus shifter 132. In some embodiments, mechanical interface 208 is a flange configured to accommodate a particular focus shifter 132. Thus, in such embodiments, multi-source interface module 131 can be mechanically coupled to an existing focus shifter 132 for a laser-scanning head, such as laser-scanning head 133 in FIG. 1.

In the embodiment described above, multi-source interface module 131 includes at least one movable optical element. Alternatively, in some embodiments, some or all of optical elements 220 are static optical elements that are fixed in position within multi-source interface module 131. For example, in such embodiments, optical elements 220 may include mirrors and/or lenses that are positioned to direct first laser beam 211, second laser beam 212, and third laser beam 213 to collimator 230.

### Alternative Implementations

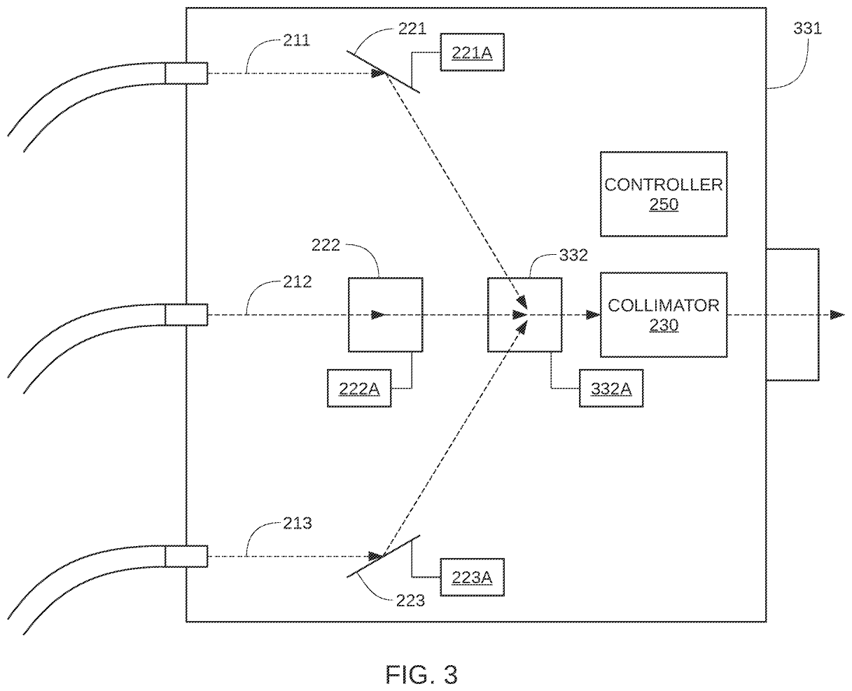

In some embodiments, optical elements 220 include a single optical element that directs first laser beam 211, second laser beam 212, and third laser beam 213 to collimator 230. In some embodiments, first movable mirror 221 directs first laser beam 211 to the single optical element, second movable mirror 222 directs second laser beam 212 to the single optical element, and third movable mirror 223 directs third laser beam 213 to the single optical element. One such embodiment is illustrated in FIG. 3.

FIG. 3 is a more detailed illustration of multi-source interface module 131 of laser-engraving system 100, according to other various embodiments. In the embodiment illustrated in FIG. 3, multi-source interface module 31 is similar to multi-source interface module 131 in FIG. 2, except that in FIG. 3 multi-source interface module 131 includes a movable mirror 332 that is configured to direct laser beams received by multi-source interface module 131 to collimator 230. In some embodiments, movable mirror 332 is mechanically coupled to a mirror-moving mechanism 332A, which can be configured to rotate and/or linearly translate movable mirror 332.

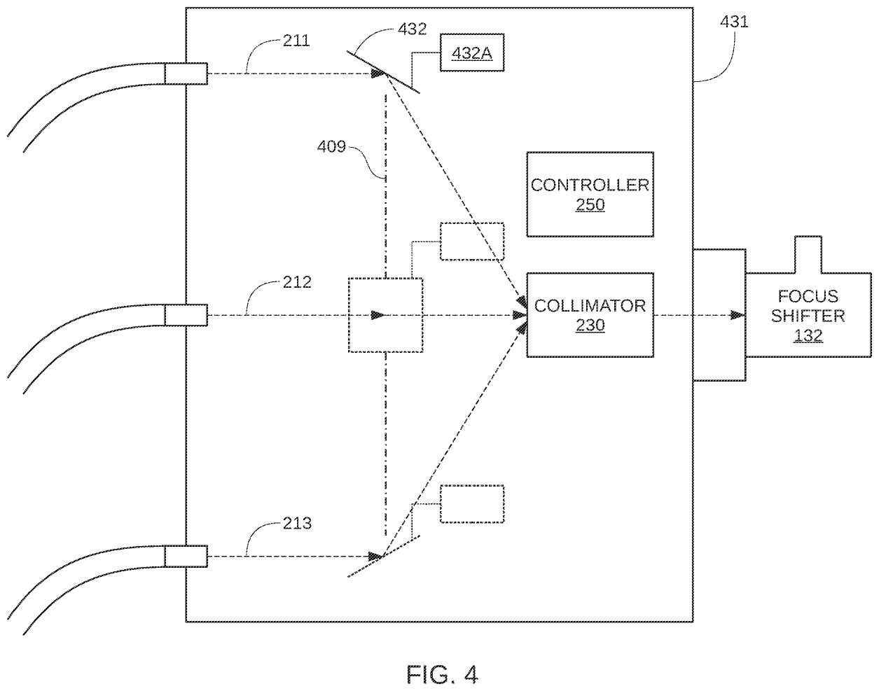

Further, in the embodiment illustrated in FIG. 3, first laser beam 211, second laser beam 212, and third laser beam 213 are each directed to collimator 230 via two movable mirrors. Specifically, first laser beam 211 is directed to collimator 230 via first movable mirror 221 and movable mirror 332, second laser beam 212 is directed to collimator 230 via second movable mirror 222 and movable mirror 332, and third laser beam 213 is directed to collimator 230 via third movable mirror 223 and movable mirror 332. In such embodiments, first laser beam 211, second laser beam 212, and third laser beam 213 each enter collimator 230 along substantially the same path, which can simplify the configuration of collimator 230. In some embodiments, optical elements 220 include a single optical element that directs first laser beam 211, second laser beam 212, and third laser beam 213 to collimator 230 from optical fiber connectors 201, 202, and 203. One such embodiment is illustrated in FIG. 4.

FIG. 4 is a more detailed illustration of a multi-source interface module 431 of laser-engraving system 100, according to other various embodiments. Multi-source interface module 431 is similar to multi-source interface module 131 in FIG. 3, except that multi-source interface module 431 is configured to selectively direct laser beams received by multi-source interface module 431 to collimator 230 via a single movable mirror 432. In some embodiments, movable mirror 432 is mechanically coupled a mirror-moving mechanism 432A, which can be configured to rotate and/or linearly translate movable mirror 432. In such embodiments, movable mirror 432 is linearly translated to different locations and/or rotated by mirror-moving mechanism 432A to different orientations within multi-source interface module 431, so that one of first laser beam 211, second laser beam 212, or third laser beam 213 is selectively directed to collimator 230. For example, in the embodiment illustrated in FIG. 4, movable mirror 432 is translated linearly along an axis 409 and/or rotated by mirror-moving mechanism 432A.

The above embodiments of optical elements 220 are provided as example configurations, and are not intended to limit the scope of the embodiments described herein. Thus, in some embodiments, optical elements 220 may include one or more movable optical elements that are arranged in any technically feasible configuration that enables first laser beam 211, second laser beam 212, and third laser beam 213 to be selectively directed to collimator 230.

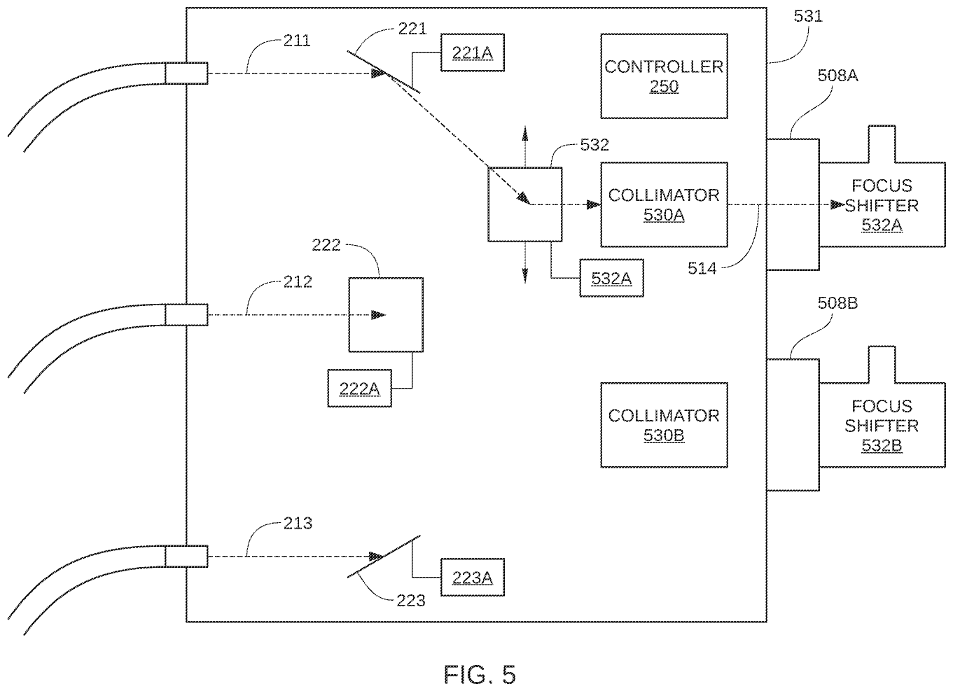

In some embodiments, a multi-source interface module is configured to selectively direct laser beams received by the multi-source interface module to two or more collimators. One such embodiment is illustrated in FIG. 5.

FIG. 5 is a more detailed illustration of a multi-source interface module 131 of laser-engraving system 100, according to other various embodiments. Multi-source interface module 531 is similar to multi-source interface module 131 in FIG. 3, except that multi-source interface module 531 is configured to selectively direct laser beams received by multi-source interface module 531 to either of two collimators 530A or 530B. In the embodiment illustrated in FIG. 5, a translatable mirror 532 is configured to be repositioned within multi-source interface module 531 by a mirror-moving mechanism 532A, which can be configured to rotate and/or linearly translate movable mirror 432. As a result, one of first laser beam 211, second laser beam 212, or third laser beam 213 can be selectively directed to either collimator 530A or 530B. A resultant collimated laser beam 514 is then directed to either a focus shifter 532A that is coupled to a first laser-scanning head (not shown) or to a focus shifter 532B that is coupled to a second laser-scanning head (not shown). Thus, in the embodiment illustrated in FIG. 5, first laser beam 211, second laser beam 212, and/or third laser beam 213 can be selectively directed to either of two different laser-scanning heads that are included in a single laser-engraving system.

In sum, the various embodiments described herein provide an optical device that selectively directs a laser beam from one of multiple laser sources to a laser-scanning head. In some embodiments, the optical device includes one or more movable mirrors for directing the laser beam to the laser-scanning head. In some embodiments, the optical device further includes a collimator configured to receive a selectively directed laser beam, produce a collimated laser beam, and direct the collimated beam to the laser-scanning head.

At least one technical advantage of the disclosed system relative to the prior art is that the disclosed system enables multiple laser-scanning operations to be performed on a given workpiece surface without having to move the workpiece to different laser-scanning stations. Thus, with the disclosed system, the workpiece does not need to be repositioned between laser-scanning operations. As a result, high-resolution features that can be formed by nanosecond, picosecond, and femtosecond laser sources can be generated on a workpiece surface even when multiple laser sources and multiple laser-scanning operations are needed to generate those features. A further advantage is that multiple laser-scanning operations can be performed on a workpiece without the delay associated with repositioning the workpiece on different laser-scanning stations. These technical advantages provide one or more technological advancements over prior art approaches.

1. In some embodiments, an optical device comprises: a first connector for a first optical fiber that transmits a first laser beam from a first laser source; a second connector for a second optical fiber that transmits a second laser beam from a second laser source; and one or more optical elements that direct the first laser beam from the first connector to a first beam collimator and direct the second laser beam from the second connector to the first beam collimator, wherein, the first beam collimator: produces a first collimated beam based on the first laser beam, directs the first collimated beam to a laser-scanning device, produces a second collimated beam based on the second laser beam, and directs the second collimated beam to the laser-scanning device.

2. The optical device of clause 1, wherein the one or more optical elements have fixed positions and do not move within the optical device.

3. The optical device of clauses 1 or 2, wherein the one or more optical elements include at least one movable mirror that directs both the first laser beam and the second laser beam to the first beam collimator.

4. The optical device of any of clauses 1-3, wherein the at least one movable mirror is coupled to a rotational actuator that rotates the at least one movable mirror relative to the first laser beam and the second laser beam.

5. The optical device of any of clauses 1-4, wherein the at least one movable mirror is coupled to a first translational actuator that moves the at least one movable mirror linearly relative to the first laser beam and the second laser beam along a first axis.

6. The optical device of any of clauses 1-5, wherein the first translational actuator further moves the at least one movable mirror linearly relative to the first laser beam and the second laser beam along a second axis.

7. The optical device of any of clauses 1-6, wherein the first translational actuator moves the at least one movable mirror within a plane perpendicular to the first laser beam after the first laser beam exits the first optical fiber and within a plane perpendicular to the second laser beam after the second laser beam exists the second optical fiber.

8. The optical device of any of clauses 1-7, further comprising a second beam collimator that: produces a third collimated beam based on the first laser beam; directs the third collimated beam to another laser-scanning device; produces a fourth collimated beam based on the second laser beam; and directs the fourth collimated beam to the another laser-scanning device.

9. The optical device of any of clauses 1-8, further comprising a controller that is configured to cause the one or more optical elements to selectively direct the first laser beam to the first beam collimator or to the second beam collimator.

10. The optical device of any of clauses 1-9, wherein the second collimated beam further aligns the third collimated beam with a focus shifter associated with another laser-scanning device.

11. The optical device of any of clauses 1-10, wherein the first connector is adapted to connect to a first photonic crystal fiber, and the second connector is adapted to connect a second photonic crystal fiber.

12. The optical device of any of clauses 1-11, wherein the first beam collimator further aligns the first collimated beam with a focus shifter associated with the laser-scanning device.

13. In some embodiments, a system comprises: a first laser source that generates a first laser beam and is optically coupled to a first optical fiber that transmits the first laser beam; a second laser source that generates a second laser beam and is optically coupled to a second optical fiber that transmits the second laser beam; and an optical device that includes: a first connector for the first optical fiber; a second connector for the second optical fiber; and one or more optical elements that direct the first laser beam from the first connector to a first beam collimator and direct the second laser beam from the second connector to the first beam collimator, wherein, the first beam collimator: produces a first collimated beam based on the first laser beam, directs the first collimated beam to a laser-scanning device, produces a second collimated beam based on the second laser beam, and directs the second collimated beam to the laser-scanning device.

14. The system of clause 13, wherein the one or more optical elements have fixed positions and do not move within the optical device.

15. The system of clauses 13 or 14, wherein the one or more optical elements include at least one movable mirror that directs both the first laser beam and the second laser beam to the first beam collimator.

16. The system of any of clauses 13-15, wherein the at least one movable mirror is coupled to a rotational actuator that rotates the at least one movable mirror relative to the first laser beam and the second laser beam.

17. The system of any of clauses 13-16, wherein the at least one movable mirror is coupled to a first translational actuator that moves the at least one movable mirror linearly relative to the first laser beam and the second laser beam along a first axis.

18. The system of any of clauses 13-17, wherein the first translational actuator further moves the at least one movable mirror linearly relative to the first laser beam and the second laser beam along a second axis.

19. The system of any of clauses 13-18, wherein the first beam collimator further aligns the first collimated beam with a focus shifter associated with the laser-scanning device.

20. The system of any of clauses 13-19, further comprising a controller that is configured to cause the one or more optical elements to selectively direct at least one of the first laser beam or the second laser beam to the first beam collimator.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. An optical device, comprising:
a first connector for a first optical fiber that transmits a first laser beam from a first laser source;
a second connector for a second optical fiber that transmits a second laser beam from a second laser source; and
one or more optical elements that direct the first laser beam from the first connector to a first beam collimator and direct the second laser beam from the second connector to the first beam collimator,
wherein, the first beam collimator:
produces a first collimated beam based on the first laser beam,
directs the first collimated beam to a laser-scanning device, produces a second collimated beam based on the second laser beam, and
directs the second collimated beam to the laser-scanning device.

2. The optical device of claim 1, wherein the one or more optical elements have fixed positions and do not move within the optical device.

3. The optical device of claim 1, wherein the one or more optical elements include at least one movable mirror that directs both the first laser beam and the second laser beam to the first beam collimator.

4. The optical device of claim 3, wherein the at least one movable mirror is coupled to a rotational actuator that rotates the at least one movable mirror relative to the first laser beam and the second laser beam.

5. The optical device of claim 3, wherein the at least one movable mirror is coupled to a first translational actuator that moves the at least one movable mirror linearly relative to the first laser beam and the second laser beam along a first axis.

6. The optical device of claim 5, wherein the first translational actuator further moves the at least one movable mirror linearly relative to the first laser beam and the second laser beam along a second axis.

7. The optical device of claim 3, wherein the first translational actuator moves the at least one movable mirror within a plane perpendicular to the first laser beam after the first laser beam exits the first optical fiber and within a plane perpendicular to the second laser beam after the second laser beam exists the second optical fiber.

8. The optical device of claim 1, further comprising a second beam collimator that:
produces a third collimated beam based on the first laser beam;
directs the third collimated beam to another laser-scanning device;
produces a fourth collimated beam based on the second laser beam; and
directs the fourth collimated beam to the another laser-scanning device.

9. The optical device of claim 8, further comprising a controller that is configured to cause the one or more optical elements to selectively direct the first laser beam to the first beam collimator or to the second beam collimator.

10. The optical device of claim 8, wherein the second collimated beam further aligns the third collimated beam with a focus shifter associated with another laser-scanning device.

11. The optical device of claim 1, wherein the first connector is adapted to connect to a first photonic crystal fiber, and the second connector is adapted to connect a second photonic crystal fiber.

12. The optical device of claim 1, wherein the first beam collimator further aligns the first collimated beam with a focus shifter associated with the laser-scanning device.

13. A system, comprising:
a first laser source that generates a first laser beam and is optically coupled to a first optical fiber that transmits the first laser beam;
a second laser source that generates a second laser beam and is optically coupled to a second optical fiber that transmits the second laser beam; and
an optical device that includes:
a first connector for the first optical fiber;
a second connector for the second optical fiber; and
one or more optical elements that direct the first laser beam from the first connector to a first beam collimator and direct the second laser beam from the second connector to the first beam collimator,
wherein, the first beam collimator:
produces a first collimated beam based on the first laser beam,
directs the first collimated beam to a laser-scanning device, produces a second collimated beam based on the second laser beam, and
directs the second collimated beam to the laser-scanning device.

14. The system of claim 13, wherein the one or more optical elements have fixed positions and do not move within the optical device.

15. The system of claim 13, wherein the one or more optical elements include at least one movable mirror that directs both the first laser beam and the second laser beam to the first beam collimator.

16. The system of claim 15, wherein the at least one movable mirror is coupled to a rotational actuator that rotates the at least one movable mirror relative to the first laser beam and the second laser beam.

17. The system of claim 15, wherein the at least one movable mirror is coupled to a first translational actuator that moves the at least one movable mirror linearly relative to the first laser beam and the second laser beam along a first axis.

18. The system of claim 17, wherein the first translational actuator further moves the at least one movable mirror linearly relative to the first laser beam and the second laser beam along a second axis.

19. The system of claim 13, wherein the first beam collimator further aligns the first collimated beam with a focus shifter associated with the laser-scanning device.

20. The system of claim 13, further comprising a controller that is configured to cause the one or more optical elements to selectively direct at least one of the first laser beam or the second laser beam to the first beam collimator.
